(19) United States
(12) Patent Application Publication
(10) Pub. No.: US 2002/0166069 A1
(43) Pub. Date: Nov. 7, 2002

(54) Network-monitoring system

(76) Inventor: David M. Zendzian, San Francisco, CA (US)

Correspondence Address: HOYT A. FLEMING III, P.O. BOX 140678, BOISE, ID, 83714, US

(21) Appl. No.: 09/848,870

(22) Filed: May 4, 2001

(51) Int. Cl. H04L 9/00

(52) U.S. Cl. 713/201

(57) ABSTRACT

A method of displaying network data including: entering a request for the network data into a computer; creating a network data request; transmitting the network data request from the computer to a server; verifying the network data request by comparing the network data request to criteria defined by a business rule; obtaining the network data; creating a data response; transmitting the first data response from the server to the computer; and displaying the network data.

### 1. FIELD OF THE INVENTION

The present invention generally relates to computer interconnection and networking. More specifically, the present invention relates to an improved method for monitoring complex computer networks.

### 2. BACKGROUND

The interconnection of computers into large operational groups has become common. With the introduction of powerful small computers, efficient decentralized (network) computing systems have replaced older centralized (mainframe) computing systems. In addition, the ever-increasing uses of computing systems now require communication and interaction between large numbers of computers.

Until recently, even the most complex existing computer networks were small enough to be fairly easily managed. A typical Local Area Network (“LAN”) was often located in a single building or office and contained a relatively small number of workstations, with a single server controlling all communication between the workstations. An individual known as a “network manager” would typically be familiar with all of the components of the network. Thus, the network manager would be able to easily manage the network. In addition, the network manager would be able to rapidly detect if the server or a workstation was not operating properly. However, today's computer networks are often so expansive that a network manager has difficulty even keeping track of all of the devices connected to the network, let alone verifying that the devices are functioning properly. Increasingly, networks are connected to other networks to form complex computer interconnection schemes that may have a worldwide scope. In such complex networks, users may be added or removed daily. Similarly, in such networks, equipment may be added or removed daily. Thus, it is no longer possible for a single individual to effectively manage such a complex network.

As the complexity of computer networks has increased, the number of users relying on such networks has likewise increased. Thus, if a salesman is unable to access a server running his company's inventory and/or pricing systems, then the salesman may find it impossible to perform his job and his company may loose a significant number of sales. In addition, with today's “e-commerce” business models, a company may also loose a significant number of sales if the company's customers around the globe are unable to access the company's web server.

Because of the importance of such servers, the company's network managers, or their personnel, often constantly monitor the status of such servers. So that the company's network managers are able to properly diagnose the status of such servers, the network managers need to be provided with detailed data regarding the status of such servers and possibly other devices such as routers, firewalls, etc.

Because of the disastrous financial effect of such servers being unavailable, company executives, such as the vice-president of sales, may also desire to monitor the servers as well. However, company executives do not need the detailed data that may be required by the company's network managers. Instead, such executives may only need to be apprised of whether salesmen and customers are able to place orders with the company.

Further, non-company personnel, such as the customers of the company, may desire to know whether the company can receive customer orders. Company shareholders may also desire similar information because of the severe financial impact that may result from non-functional sales systems. However, such non-company personnel must not be allowed to retrieve confidential information that is available to the company's network managers and/or executives.

Thus, a need exists for a network-monitoring system that is capable of providing varying amounts of network status data to users based upon a user's relationship to a company.

### 3. SUMMARY OF INVENTION

One embodiment of the invention is a method of displaying network data. The method includes: entering a request for the network data into a computer; creating a network data request; transmitting the network data request from the computer to a server; verifying the network data request by comparing the network data request to criteria defined by a business rule; obtaining the network data; creating a data response; transmitting the first data response from the server to the computer; and displaying the network data.

Another embodiment of the invention is another method of displaying network data. This method includes: entering a request for the network data into a computer; creating a first network data request; transmitting the first network data request from the computer to a first server; verifying the first network data request; creating a second network data request; transmitting the second network data request from the first server to a second server; verifying the second network data request; obtaining the network data; creating a first data response; transmitting the first data response from the second server to the first server; verifying the first data response; creating a second data response; verifying the second data response; transmitting the second data response from the second server to the computer; and displaying the network data.

Still another embodiment of the invention is a program storage device. The program storage device includes computer readable instructions that when executed by a server: verify a network data request by comparing the network data request to criteria defined by a business rule; obtain network data; create a data response; and transmit the data response from the server to a computer.

Still another embodiment of the invention is a method of verifying the authenticity of software. The method includes: based upon the software, generating a text string; based upon the text string, generating a first hash value; and comparing the first hash value with a second hash value.

### 4. BRIEF DESCRIPTION OF THE FIGURES

FIG. 1 presents a method of configuring monitoring server software.

FIG. 2 presents a method of configuring gateway software.

FIG. 3 presents a method of configuring client software.

FIG. 4(a) presents a first portion of a method of providing network data to a user.

FIG. 4(b) presents a second portion of a method of providing network data to a user.

FIG. 5 presents a method of modifying a company structure.

FIG. 6 presents a method of displaying network data on a computer.

FIG. 7 presents still another method of displaying network data on a computer.

FIG. 8 presents a method of verifying software.

### 5. DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In order to present varying network information to users based upon the user's relationship to a company, first software must be installed and configured on one or more computer systems. More specifically, in some embodiments of the invention, monitoring software, gateway software, and client software must be installed and configured.

5.1 Install the Monitoring Software on a Server

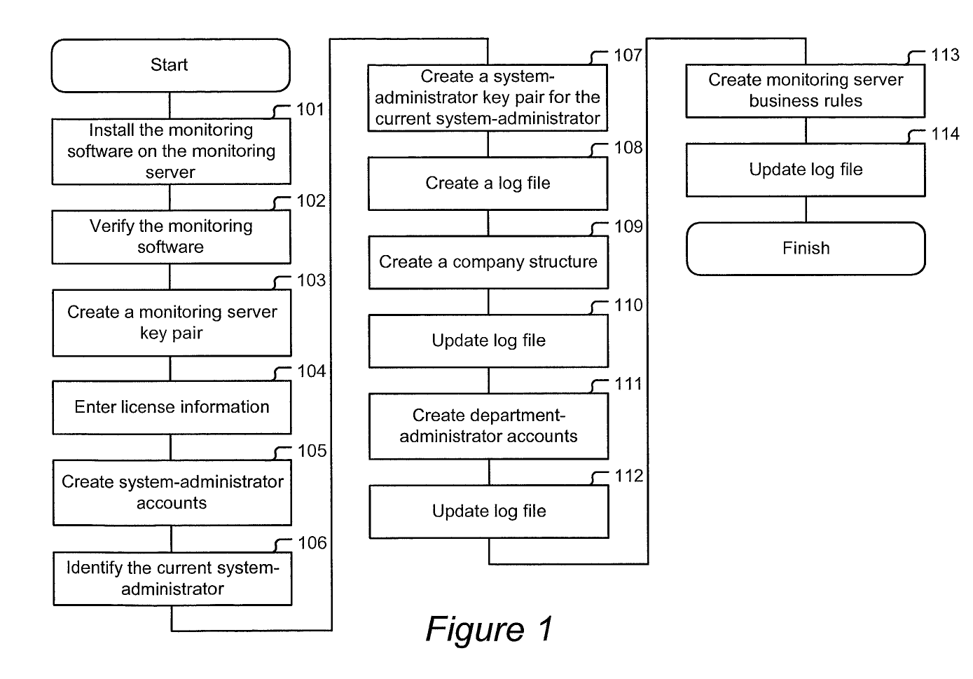

Referring to block 101 of FIG. 1, a system-administrator that desires to utilize the monitoring software would first install the monitoring software on a server. The server may be any type of computing device that manages network resources. For example, the server may be a file server, a database server, a print server, or a combination of the above. In addition, the server may be a computer system that is coupled to one or more of the above servers. The monitoring software may be installed by loading the monitoring software onto a disk drive that is coupled to the server.

5.2 Configure the Monitoring Software on a Server

After the monitoring software has been installed on the server, which will be referred to as the monitoring server, the system-administrator would run the monitoring software for the first time. When the monitoring software is first run, in some embodiments of the invention, the monitoring software would prompt the system-administrator for data that is needed to configure the monitoring software.

5.2.1 Verify the Monitoring Software

Referring to block 102 of FIG. 1, in some embodiments of the invention, the monitoring software would verify whether a third party has tampered with the monitoring software by generating a hash value from a text string based upon the software. For example, the monitoring software could create a hash value based upon a text string that includes some or all of the following: the names of one or more files in the monitoring software; the date of such files; the directory of such files; and the size of such files. After the monitoring software has created the hash value, the monitoring software would compare the created hash value to a hash value that has been provided by the monitoring software vendor. In some embodiments of the invention, the hash value provided by the monitoring software vendor would be included on the same media that includes the monitoring software. In other embodiments of the invention, the hash value may be provided to the system-administrator via the Internet, via a facsimile, via a telephone call, via an unencrypted e-mail, via an encrypted e-mail, or via a written document.

If the monitoring software determines that the created hash value is not equal to the provided hash value, in some embodiments of the invention, the monitoring software would create an error. After reviewing the error, the system-administrator can decide whether to continue the install process or abort the install process.

In other embodiments of the invention, the monitoring software may create a checksum of one or more files included in the monitoring software. In such embodiments, the created checksum would be compared to a checksum that was provided by the monitoring software vendor to the system-administrator by one of the means described above.

5.2.2 Create a Monitoring Server Key Pair

Referring to block 103 of FIG. 1, the monitoring software next creates a monitoring server key pair. As will be discussed in Sections 5.4.2 and 5.4.5, the monitoring server key pair is utilized to authenticate transactions and to log any revisions to monitoring software data structures. The monitoring server key includes a public server key and a private server key. In addition, the monitoring server key pair may include a password. Use and operation of key pairs are well known by those of skill in the art.

5.2.3 Enter License Information

Referring to block 104 of FIG. 1, the system-administrator next enters licensing information. Such licensing information may include the name of the company that operates the monitoring server, the company address, and the location of the monitoring server. The licensing information may also include the name of the building or the name of the room in which the monitoring server is located. Further, such location information may also include the name of the monitoring server.

After the system-administrator enters the above licensing information, in some embodiments of the invention, the licensing information is digitally signed using the monitoring server's private key and then is stored on the monitoring server.

5.2.4 Create System-Administrator Accounts

Referring to block 105 of FIG. 1, the system-administrator next creates one or more system-administrator accounts. A system-administrator account is a data structure that identifies one or more system-administrators and defines the monitoring software data structures that the system-administrator may modify. In some embodiments of the invention, system-administrator accounts are stored in a database on the monitoring server. In other embodiments of the invention, system-administrator accounts are stored on the monitoring server in a file, such as a flat file.

In one embodiment of the invention, the system-administrator manually enters information that identifies one or more system-administrators and the monitoring software data structure modification rights that they possess. In other embodiments of the invention, the system-administrator identifies a file or a server that contains such information. For example, the system-administrator may enter information that identifies a Windows NT server, a PKI server, or an LDAP server. In still other embodiments of the invention, a portion of the above information is manually input by the system-administrator and a portion of the information is retrieved from a server or a file.

5.2.4.1 Rights to Modify Monitoring Server Data Structures

As discussed in section 5.2.4, the system-administrator accounts define the rights that a system-administrator has to modify monitoring software data structures. Examples of such rights include: the right to create system-administrator rights, the right to delete system-administrator rights, the right to create department-administrator rights as discussed in section 5.2.10, the right to delete department-administrator rights, the right to modify the company structure as discussed, the right to create monitoring server business rules, the right to modify monitoring server business rules, and the right to delete monitoring server business rules.

5.2.5 Identify the Current System-Administrator

Referring to block 106 of FIG. 1, the system-administrator next provides the monitoring software with information that identifies him as the current system-administrator. For example, the current-system administrator may provide his user ID and password.

5.2.6 Create a System-Administrator Key Pair for the Current System-Administrator

Next, referring to block 107 of FIG. 1, after the monitoring software receives the current system-administration information, in some embodiments of the invention, the monitoring software creates a system-administrator key pair and associates the key pair with the current system-administrator information.

5.2.7 Create Log File

After the creation of the system-administrator key pair, referring to block 108 of FIG. 1, in some embodiments of the invention, the monitoring software creates a log file on the monitoring server that includes some or all of the following: the identity of the current system-administrator; the system-administrator accounts that the current system-administrator created in Section 5.2.4; the date that the accounts were created; and the time that the accounts were created. The purpose of the log file is to document the configuration of the monitoring software. In some embodiments of the invention, the log file is also used to document all additions, modifications and deletions to the monitoring software data structures. In some embodiments of the invention, the log file would be stored on a program storage device such as a hard disk drive of the monitoring server in an unencrypted format. However, in other embodiments of the invention, the log file would be digitally signed with the system-administrator's private key and/or the monitoring server's private key before being stored on a program storage device.

5.2.8 Create Company Structure

Next, in some embodiments of the invention, one of the system-administrators, which may or may not be the system-administrator that created the system-administrator accounts in section 5.2.4, logs into the monitoring software. If the system-administrator does not already have a system-administrator key pair, then a new system-administrator key pair is created and associated with the current system-administrator. After the system-administrator has logged into the monitoring software, referring to block 109 of FIG. 1, he can create the “company structure.” The company structure is a data structure that defines some or all of the identities of the organizations within the company. For example, the company structure may include the identities of the following organizations: executive; information technology; human resources; sales; marketing; operations; accounting; and legal. In addition, the company structure may also include subparts of an organization. Examples of such subparts include: salesman, sales managers, and sales directors. In addition, the company structure may include the identities of organizations that are external to the company, such as prospective customers, customers, vendors, and investors. The company structure may also include subparts of organizations that are external to the company such as: former customers, top-tier customers, and bottom-tier customers.

In some embodiments of the invention, the company structure may also include information, such as user ID, user password, and user public key, which identifies users in each organization and/or subpart of an organization.

In one embodiment of the invention, the system-administrator manually enters the above information. In other embodiments of the invention, the system-administrator identifies a server that contains such information. In still other embodiments of the invention, a portion of the above information is manually input by the system-administrator and a portion of the information is retrieved from a server.

5.2.9 Update Log File

After the system-administrator has created the company structure, referring to block 110 of FIG. 1, in some embodiments of the invention, the log file created in section 5.2.7 is updated to include the identity of the system-administrator that created the company structure. In some embodiments of the invention, such information is digitally signed with the system-administrator's private key and/or the monitoring server's private key.

5.2.10 Create Department-Administrator Accounts

Referring to block 111 of FIG. 1, in some embodiments of the invention, the system-administrator next creates one or more department-administrator accounts. A department-administrator account is a data structure that identifies one or more department-administrators and the monitoring software data structure modification rights that each department-administrator possesses. In some embodiments of the invention, system-administrators can delegate certain monitoring software data structure modification rights to department-administrators. In some embodiments, the department-administrators can also delegate certain monitoring software data structures to other department-administrators and/or to users. Thus, in some embodiments of the invention, an efficient hierarchical system can be put in place for revising monitoring software data structures.

In some embodiments of the invention, a department-administrator is only provided with a limited set of monitoring software data structure modification rights. For example, a department-administrator may only possess monitoring software data structure modification rights that relate to his organization. However, a single individual may, in some circumstances, be a department-administrator for multiple organizations. In such cases, the individual would have monitoring software data structure modification rights for each of those organizations.

In some embodiments of the invention, department-administrator accounts are stored in a database on the monitoring server. In other embodiments of the invention, department-administrator accounts are stored in a file on the monitoring server, such as a flat file.

In one embodiment of the invention, the current system-administrator manually enters the above information. In other embodiments of the invention, the current system-administrator identifies a server that contains such information. In still other embodiments of the invention, a portion of the above information is manually input by the system-administrator and a portion of the information is retrieved from a server.

5.2.11 Update Log File

After the system-administrator has created the department-administrator accounts, referring to block 112 of FIG. 1, in some embodiments of the invention, the log file is updated to include the identity of the system-administrator that created the department-administrator accounts. In some embodiments of the invention, such information is digitally signed by the system-administrator's private key and/or the monitoring server's private key.

5.2.12 Create Monitoring Server Business Rules

After the log file has been updated, referring to block 113 of FIG. 1, an administrator, i.e. a system-administrator or a department-administrator, next enters one or more “monitoring server business rules.” A monitoring server business rule is a data structure that defines the circumstances in which the monitoring server can communicate with other servers, gateways, client computers and/or users. The monitoring server business rules are typically stored on the monitoring server.

In some embodiments of the invention, a first monitoring server business rule may allow all communications between the monitoring server and a second server. A second monitoring server business rule may allow communications between the monitoring server and a third server only if the person requesting the communication is a particular system-administrator or if the person is in a particular organization or organization subpart. Similarly, a third monitoring server business rule may allow all communications between the monitoring server and a first gateway server. Further, a fourth monitoring server business rule may allow particular communications between the monitoring server and a second gateway server only if the client computer requesting the communication is a particular client computer and the person requesting the communication is in a particular organization. The above examples of monitoring server business rules are not exhaustive. One of skill in the art, with the benefit of this disclosure, will recognize that many such monitoring server business rules are possible.

In some embodiments of the invention, a communication to or from a particular server will not be allowed unless a specific monitoring server business rule allows the communication. In other embodiments of the invention, such a communication is allowed unless a specific monitoring server business rule prohibits the communication.

5.2.13 Update Log File

After the administrator has created the monitoring server business rules, referring to block 114 of FIG. 1, the log file is updated to include the identity of the administrator that created the monitoring server business rules. In some embodiments of the invention, such information is digitally signed with the administrator's private key and/or the monitoring server's private key.

At this point, the monitoring software on the server has been configured.

5.3 Install Gateway Software

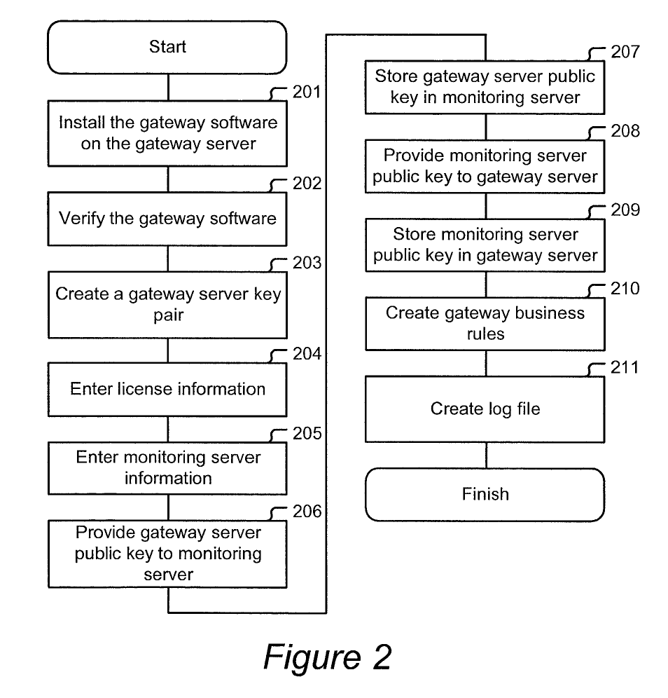

After the monitoring software on the monitoring server has been configured, as shown in block 201 of FIG. 2, the gateway software is installed on a server. The gateway software allows communication between the monitoring server and the server running the gateway software, which will be referred to as the gateway server. In addition, the gateway software allows communication between the gateway server and client computers.

In some embodiments of the invention, the gateway software is installed on the monitoring server. However, in many embodiments of the invention, the gateway software is installed on a different server. The gateway software may be installed by loading the gateway software onto a disk drive that is coupled to the gateway server.

5.4 Configure the Gateway Software on a Server

After the gateway software has been installed, a system-administrator would run the gateway software for the first time. When the gateway software is first run, in some embodiments of the invention, the gateway software would prompt the system-administrator for data that is needed to configure the gateway software.

5.4.1 Verify the Gateway Software

In some embodiments of the invention, as shown in block 202 of FIG. 2, the gateway software could be verified using methods similar to those described in Section 5.2.1.

5.4.2 Create Gateway Key

Referring to block 203 of FIG. 2, in some embodiments of the invention, the gateway software next creates a gateway server key pair. The gateway server key pair is utilized to authenticate transactions between the monitoring server and the gateway server. The key pair is also utilized to authenticate transactions between the gateway server and client computers.

5.4.3 Enter License Information

Referring to block 204 of FIG. 2, in some embodiments of the invention, the system-administrator next enters license information. Such license information may include the name of the company that operates the gateway server, the company address, and the location of the gateway server. The license information may also include the name of the building or the name of the room in which the gateway server is located. Further, such location information may also include the name of the gateway server.

5.4.4 Enter Monitoring Server Information

Referring to block 205 of FIG. 2, the system-administrator next provides the gateway software with information that identifies the monitoring server. Such information may include the address and name of the monitoring server, as well as any other information, such as a password, that is required to communicate with the monitoring server.

5.4.5 Exchange Keys Between the Monitoring Server and the Gateway Server

Referring to block 206 of FIG. 2, in some embodiments of the invention, the gateway software provides the gateway server's public key to the monitoring server. Then, referring to block 207 of FIG. 2, the monitoring server stores the gateway server's public key in a program storage device, such as a hard disk drive, that is coupled to the monitoring server.

Next, as shown in block 208 of FIG. 2, in some embodiments of the invention, the monitoring server provides the monitoring server's public key to the gateway server. Then, referring to block 209 of FIG. 2, the gateway server stores the monitoring server's public key in a program storage device, such as a hard disk drive, that is coupled to the gateway server.

In some embodiments of the invention, after the two servers have exchanged public keys, all future communications between the two servers will be encrypted.

5.4.6 Gateway Business Rules

After the log file has been updated, referring to block 210 of FIG. 2, in some embodiments of the invention, an administrator next enters one or more “gateway business rules.” A gateway business rule is a data structure that is similar to a monitoring server business rule except that the gateway business rules define allowable communications to a gateway server while monitoring server business rules define allowable communications to a monitoring server. The gateway business rules are typically stored on the gateway server.

In some embodiments of the invention, a first gateway business rule may allow all communications between the gateway server and a first server. A second gateway business rule may allow communications between the gateway server and a second server only if the person requesting the communication is a particular system-administrator or if the person is in a particular organization. Similarly, a third gateway business rule may allow all communications between the gateway server and a second gateway server. Further, a fourth gateway business rule may allow certain communications between the gateway server and a client computer only if the person requesting the communication is in a particular organization. The above examples of gateway business rules are not exhaustive. One of skill in the art, with the benefit of this disclosure, will recognize that many such gateway business rules are possible.

In some embodiments of the invention, a communication to or from a particular gateway server will not be allowed unless a specific gateway business rule allows the communication. In other embodiments of the invention, such a communication is allowed unless a specific gateway business rule prohibits the communication.

In one embodiment of the invention, the administrator manually enters the above information. In other embodiments of the invention, the administrator identifies a server that contains such information. In still other embodiments of the invention, a portion of the above information is manually input by the administrator and a portion of the information is retrieved from a server.

In some embodiments of the invention, the gateway server would also include some or all of the company structures from one or more monitoring servers.

5.4.7 Create Log File

After the administrator has created the gateway business rules, referring to block 211 of FIG. 2, in some embodiments of the invention, a log file is created. The log file includes the identity of the administrator that created the gateway business rules. In some embodiments of the invention, such information is digitally signed by the administrator's private key and/or the gateway server's private key.

At this point, the gateway software on the gateway server has been configured.

5.5 Install Client Software

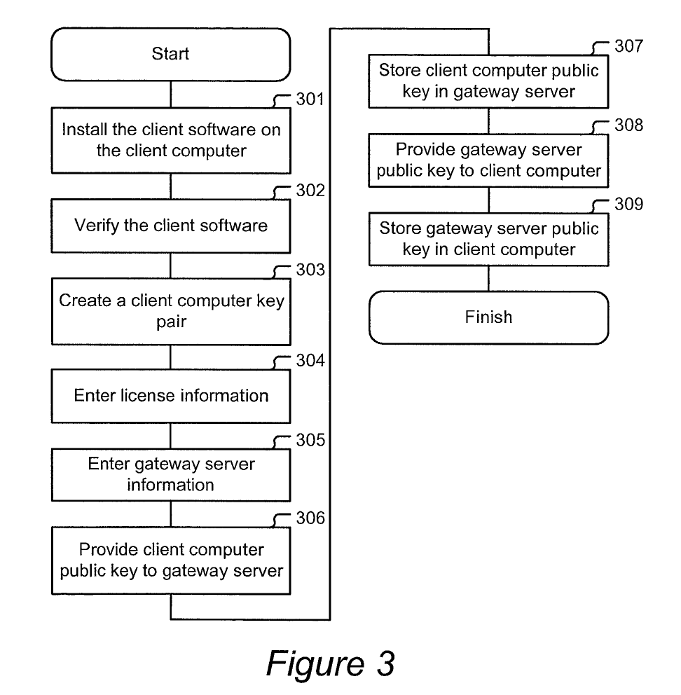

After the gateway software has been configured, as shown in block 301 of FIG. 3, the client software is installed on a client computer. The client software allows communication between the gateway server and the client computer. In some embodiments, the client software is a Web browser. In some embodiments of the invention, the client software is installed on the gateway server. However, in many embodiments of the invention, the client software is installed on a different computer. The client software may be installed by loading the client software onto a disk drive that is coupled to the client computer.

5.6 Configure the Client Software of a Client Computer

After the client software has been installed, an administrator would run the client software for the first time. In some embodiments of the invention, when the client software is first run, the client software would prompt the administrator for data that is needed to configure the client software.

5.6.1 Verify the Client Software

In some embodiments of the invention, as shown in block 302 of FIG. 3, the client software could be verified using methods similar to those described in section 5.2.1.

5.6.2 Create Client Computer Key

Referring to block 303 of FIG. 3, in some embodiments of the invention, the client software next creates a client computer key pair. The client computer key pair is utilized to authenticate transactions between the gateway server and the client computer.

5.6.3 Enter License Information

Referring to block 304 of FIG. 3, in some embodiments of the invention, the client software next requests the administrator to enter license information. Such license information may include the name of the company that operates the client computer, the company address, and the location of the client computer. The license information may also include the name of the building or the name of the room in which the client computer is located. Further, such location information may also include the name of the client computer.

5.6.4 Enter Gateway Server Information

Referring to block 305 of FIG. 3, in some embodiments of the invention, the administrator next provides the client software with information that identifies the gateway server. Such information may include the address and name of the gateway server as well as any other information, such as a password, that is required to communicate with the gateway server.

5.6.5 Exchange Keys Between the Gateway Server and the Client Computer

Referring to block 306 of FIG. 3, in some embodiments of the invention, the client software provides the client computer's public key to the gateway server. Then, referring to block 307 of FIG. 3, the gateway software stores the client computer's public key in a program storage device, such as a hard disk drive.

Next, as shown in block 308 of FIG. 3, in some embodiments of the invention, the gateway server provides the gateway server's public key to the client computer. Then, referring to bock 309 of FIG. 3, the client computer stores the gateway server's public key in a program storage device such as a hard disk drive.

After the gateway server and the client computer have exchanged public keys, in some embodiments of the invention, all future communications between the gateway server and the client computer will be encrypted.

At this point, the client software on the client computer has been configured.

5.7 Provide Network Data to Users Based Upon a User's Organization

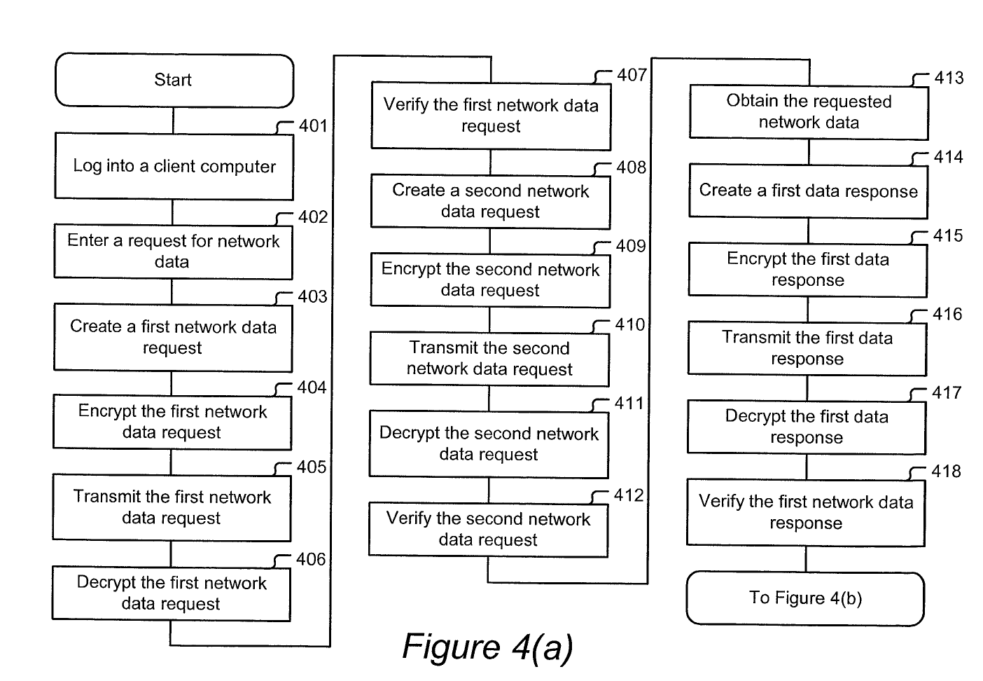

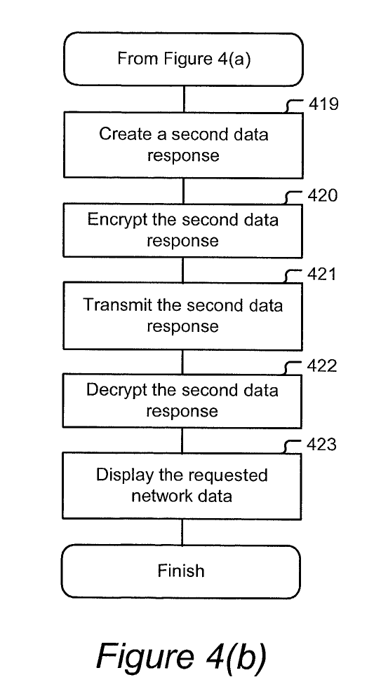

One embodiment of the invention, which is shown in FIG. 4(a) and FIG. 4(b), is a method of providing network data to a user based upon the user's company organization. Generally, the method includes generating a first network data request on a client computer and transmitting the first network data request to a gateway server. If the first network data request is valid according to the gateway business rules, then the gateway server creates a second network data request and transmits the second network data request to a monitoring server.

The monitoring server then verifies that the second network data request is valid according to the monitoring server business rules. If the second network data request is valid, the monitoring server then obtains the requested network data.

The monitoring server then creates a first response message that contains the requested network data and transmits the first response message to the gateway server. The gateway server then verifies that the first response message is valid according to the gateway business rules. If the first response message is valid, then the gateway server creates a second response message that contains the requested network data. Finally, the second response message is transmitted to the client computer and the requested network data is displayed on the client computer screen.

Each of the above steps will be discussed in more detail below.

5.7.1 Create a First Network Data Request

In one embodiment of the invention, as shown in block 401 of FIG. 4(a), a user first logs into a client computer. For example, the user may enter his user ID and user password into the client computer. After logging into the client computer, as shown in block 402 of FIG. 4(a), the user enters a request for network data into the client computer. In some embodiments of the invention, the user may also enter the name of a specific gateway server or monitoring server into the client computer. In other embodiments of the invention, the user need not manually enter such information. After the user has entered the request for network data into the client computer, as shown in blocks 403 and 405 of FIG. 4(a), the client software creates a first network data request and transmits the first network data request to a gateway server.

In some embodiments of the invention, as shown in block 404 of FIG. 4(a), the first network data request is encrypted before the request is transmitted to the gateway server. In some embodiments of the invention, the first network data request is encrypted using the user's private key, and/or the client computer's private key.

5.7.2 Create a Second Network Data Request

After the gateway server receives the first network data request from the client computer, in some embodiments of the invention, as shown in block 406 of FIG. 4(a), the gateway server decrypts the network data request using the user's public key and/or the client computer's public key. Next, as shown in block 407 of FIG. 4(a), the gateway server verifies that the network data request is valid by comparing the requested network data, the user ID, the user password and/or the client computer ID to criteria defined by the gateway business rules. If the network data request is valid according to the gateway business rules, then as shown in blocks 408 and 410 of FIG. 4(a), the gateway server creates a second network data request and transmits the request to a monitoring server.

In some embodiments of the invention, as shown in block 409 of FIG. 4(a), the second network data request is encrypted before the request is transmitted to the monitoring server. In some embodiments of the invention, the second network data request is encrypted using the gateway server's private key.

5.7.3 Generating a First Data Response

After the monitoring server receives the second network data request, in some embodiments of the invention, as shown in block 411 of FIG. 4(a), the monitoring server decrypts the second network data request using the gateway server's public key. Next, as shown in block 412 of FIG. 4(a), the monitoring server verifies that the second network data request is valid by comparing the request to the monitoring server business rules. If the second network data request is valid according to the criteria defined by the monitoring server business rules, then, as shown in block 413 of FIG. 4(a), the monitoring server obtains the requested network data. Then, as shown in blocks 414 and 416 of FIG. 4(a), the monitoring server creates a first data response that contains the requested network data and transmits the first data response to the gateway server.

In some embodiments of the invention, as shown in block 415 of FIG. 4(a), the first data response is encrypted before the first data response is transmitted to the gateway server. In some embodiments of the invention, the first data response is encrypted using the monitoring server's private key.

5.7.4 Create a Second Data Response

After the gateway server receives the first data response, in some embodiments of the invention, as shown in block 417 of FIG. 4(a), the gateway server decrypts the first data response using the monitoring server's public key. Next, as shown in block 418 of FIG. 4(a), the gateway server verifies that the first data response is valid by comparing the first data response to the gateway business rules. If the first data response is valid according to the gateway business rules, then as shown in blocks 419 and 421 of FIG. 4(b), the gateway server creates a second data response and transmits the second data response to the client computer.

In some embodiments of the invention, as shown in block 420 of FIG. 4(b), the second data response is encrypted before the second data response is transmitted to the client computer. In some embodiments of the invention, the second data response is encrypted using the gateway server's private key.

5.7.5 Display the Requested Network Data

After the client computer has received the second data response, in some embodiments of the invention, as shown in block 422 of FIG. 4(b), the client computer decrypts the second data response using the gateway server's public key. Next, as shown in block 423 of FIG. 4(b), the client computer displays the requested network data.

5.8 Revisions to Company Structure

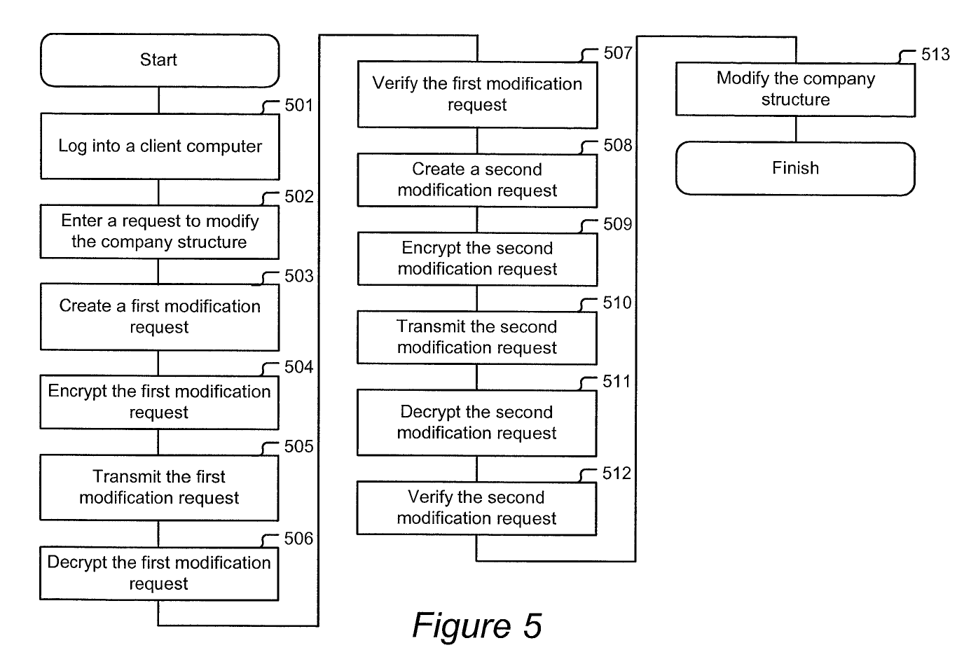

In still other embodiments of the invention, the monitoring software includes functionality that allows revisions to the company structure. For example, an administrator may desire to increase or decrease the number of organizations or organization subparts. FIG. 5 presents one method of modifying the company structure.

5.8.1 Create a First Modification Request

As shown in block 501 of FIG. 5, a user, which may or may not be an administrator, first logs into a client computer. After logging into the client computer, as shown in block 502 of FIG. 5, the user enters a request to modify the company structure. In some embodiments of the invention, the user may also enter the name of the monitoring server that contains the company structure. After the user has entered the request to modify the company structure into the client computer, as shown in blocks 503 and 505 of FIG. 5, the client software creates a first modification request and transmits the request to a gateway server.

In some embodiments of the invention, as shown in block 504 of FIG. 5, the first modification request is encrypted before it is transmitted to the gateway server. In some embodiments of the invention, the first modification request is encrypted with the user's private key and/or the client computer's private key.

5.8.2 Create a Second Modification Request

After the gateway server receives the first modification request from the client computer, in some embodiments of the invention, as shown in block 506 of FIG. 5, the gateway server decrypts the modification request using the user's public key and/or the client computer's public key. Next, as shown in block 507 of FIG. 5, the gateway server verifies that the modification request is valid by comparing the modification request, the user ID, and the user password to the gateway business rules. If the modification request is valid according to the gateway business rules, then as shown in blocks 508 and 510 of FIG. 5, the gateway server creates a second modification request and transmits the request to a monitoring server.

In some embodiments of the invention, the gateway business rules may require approval of the request for modification of the company structure. For example, approval may be required by a system-administrator and/or a department-administrator. In such embodiments, the second modification request is not transmitted unless such approval is obtained.

In some embodiments of the invention, as shown in block 509 of FIG. 5, the second modification request is encrypted before the request is transmitted to the monitoring server. In some embodiments of the invention, the second modification request is encrypted using the gateway server's private key.

5.8.3 Modify the Company Structure

After the monitoring server receives the second modification request, in some embodiments of the invention, as shown in block 511 of FIG. 5, the monitoring server decrypts the second modification request using the gateway server's public key. Next, as shown in block 512 of FIG. 5, the monitoring server verifies that the second modification request is valid by comparing the request to both the monitoring server business rules and/or administrator accounts. In some embodiments of the invention, if the second modification request is valid according to both the monitoring server business rules and the administrator accounts, then, as shown in block 513 of FIG. 5, the monitoring server modifies the company structure and stores the modified company structure on the monitoring server.

In some embodiments of the invention (not shown), the monitoring server could also create a message that is transmitted to the client computer via the gateway server that indicates that the requested modification to the company structure has been completed. Upon receipt of this message, the client computer could display the message to the user.

5.9 Revisions to Other Data Structures

Other data structures that are stored on the monitoring server and/or the gateway server could be modified according to methods similar to the method described in Section 5.8. For example, the data structure stored on the gateway server could be modified by sending a modification request to the gateway server. Next, the gateway server would verify the modification request according to the gateway business rules. If the modification request was valid, then the gateway server would modify the data structure. In some embodiments of the invention the modification request would be encrypted. However, in other embodiments of the invention, the modification request would not be encrypted.

5.10 Other Embodiments of the Invention

In the above-described embodiments, a user would communicate to a monitoring server via the gateway server. However in some embodiments of the invention, a user would communicate directly to the monitoring server.

In some embodiments of the invention, both the monitoring server and the gateway server would store system-administrator accounts, department-administrator accounts, and company structures. However, in other embodiments only the monitoring server would store such information. In still other embodiments, only the gateway server would store such information. Similarly, in some embodiments of the invention, both the monitoring server and the gateway server would store the business rules. However, in other embodiments of the invention, only the monitoring server would store business rules. In still other embodiments, only the gateway server would store business rules.

5.11 Conclusion

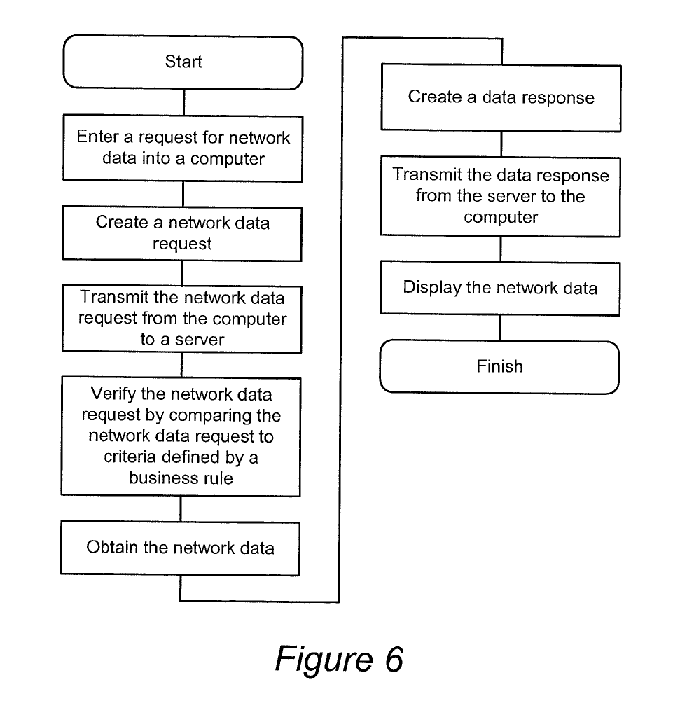

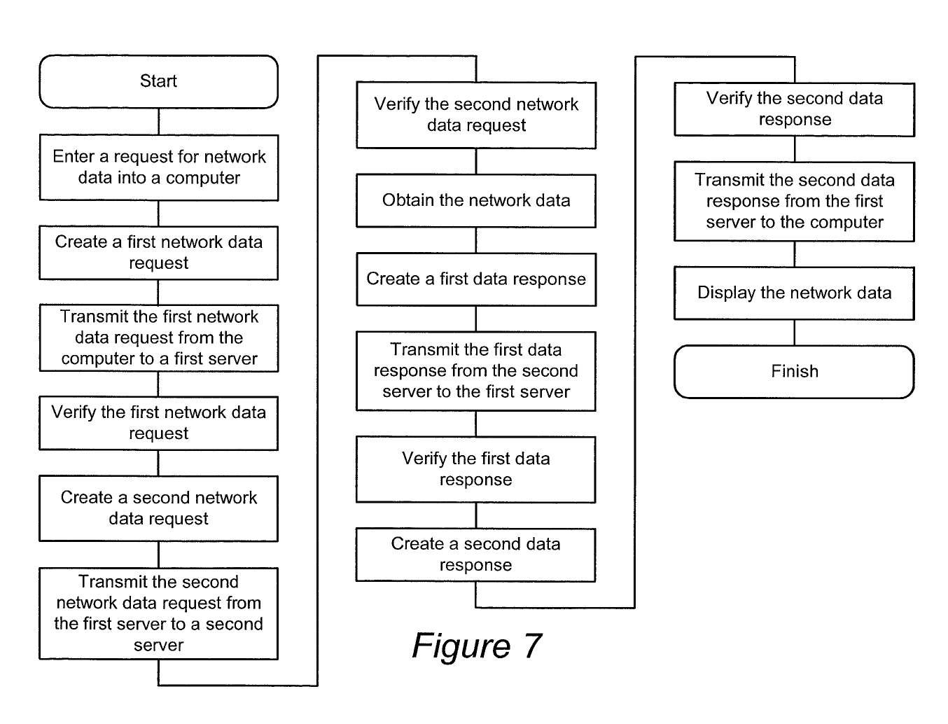

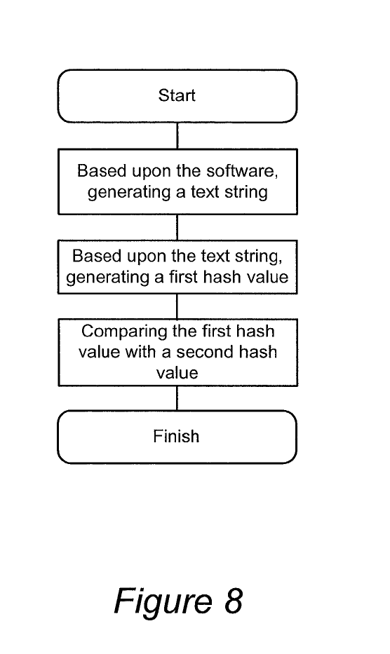

The foregoing descriptions of embodiments of the present invention have been presented for purposes of illustration and description only. They are not intended to be exhaustive or to limit the present invention to the forms disclosed. For example, the methods shown in FIGS. 6, 7, and 8 are intended to be included within the present invention. Further, a program storage device such as a hard disk drive, a compact disc (CD), a digital versatile disk (DVD), a floppy disk, or any similar device that contains computer readable instructions that when executed perform any of the above described novel methods is intended to be included in the present invention. Accordingly, many modifications and variations will be apparent to practitioners skilled in the art. Additionally, the above disclosure is not intended to limit the present invention. The scope of the present invention is defined by the appended claims.

It is claimed:

1. A method of displaying network data comprising:
a) entering a request for the network data into a computer;
b) creating a network data request;
c) transmitting the network data request from the computer to a server;
d) verifying the network data request by comparing the network data request to criteria defined by a business rule;
e) obtaining the network data;
f) creating a data response;
g) transmitting the data response from the server to the computer; and
h) displaying the network data.

2. The method of claim 1, wherein the request for the network data is entered into a browser running on the computer.

3. The method of claim 1, wherein the act of entering a request for network data includes entering a request for network data that includes the name of a gateway server.

4. The method of claim 1, wherein the act of entering a request for network data includes entering a request for network data that includes the name of a monitoring server.

5. The method of claim 1, wherein the act of transmitting the network data request includes transmitting a network data request that has been encrypted.

6. The method of claim 1, wherein the act of transmitting the network data request includes transmitting a network data request that has been encrypted via a first private key.

7. The method of claim 1, wherein the act of transmitting the network data request includes transmitting a network data request that has been encrypted via a first private key and a second private key.

8. The method of claim 1, wherein the act of verifying the network data request includes comparing the requested network data to criteria defined by a business rule.

9. The method of claim 1, wherein the act of verifying the network data request includes comparing a user ID to criteria defined by a business rule.

10. The method of claim 1, wherein the act of verifying the network data request includes comparing the organization of a user to criteria defined by a business rule.

11. The method of claim 1, wherein the act of verifying the network data request includes comparing a user password to criteria defined by a business rule.

12. The method of claim 1, wherein the act of verifying the network data request includes comparing information that identifies the computer to criteria defined by a business rule.

13. The method of claim 1, wherein the act of displaying the network data includes displaying the network data on a browser running on the computer.

14. A method of displaying network data comprising:
a) entering a request for the network data into a computer;
b) creating a first network data request;
c) transmitting the first network data request from the computer to a first server;
d) verifying the first network data request
e) creating a second network data request;
f) transmitting the second network data request from the first server to a second server;
g) verifying the second network data request;
h) obtaining the network data;
i) creating a first data response;
j) transmitting the first data response from the second server to the first server;
k) verifying the first data response;
l) creating a second data response;
m) verifying the second data response;
n) transmitting the second data response from the first server to the computer; and
o) displaying the network data.

15. The method of claim 14, wherein the request for the network data is entered into a browser running on the computer.

16. The method of claim 14, wherein the act of entering a request for network data includes entering a request for network data that includes the name of a gateway server.

17. The method of claim 14, wherein the act of entering a request for network data includes entering a request for network data that includes the name of a monitoring server.

18. The method of claim 14, wherein the act of transmitting the second network data request includes transmitting a network data request that has been encrypted.

19. The method of claim 14, wherein the act of transmitting the second network data request includes transmitting a network data request that has been encrypted via a first private key.

20. The method of claim 14, wherein the act of transmitting the second network data request includes transmitting a network data request that has been encrypted via a first private key and a second private key.

21. The method of claim 14, wherein the act of verifying the second network data request includes comparing the requested network data to criteria defined by a business rule.

22. The method of claim 14, wherein the act of verifying the second network data request includes comparing a user ID to criteria defined by a business rule.

23. The method of claim 14, wherein the act of verifying the second network data request includes comparing the organization of a user to criteria defined by a business rule.

24. The method of claim 14, wherein the act of verifying the second network data request includes comparing a user password to criteria defined by a business rule.

25. The method of claim 14, wherein the act of verifying the second network data request includes comparing information that identifies the computer to criteria defined by a business rule.

26. The method of claim 14, wherein the act of verifying the second network data request includes comparing information that identifies the first server to criteria defined by a business rule.

27. The method of claim 14, wherein the act of displaying the network data includes displaying the network data on a browser running on the computer.

28. A program storage device that contains computer readable instructions that when executed by a server perform the following:
a) verify a network data request by comparing the network data request to criteria defined by a business rule;
b) obtain network data;
c) create a data response; and
d) transmit the data response from the server to a computer.

29. A method of verifying the authenticity of software comprising:
a) based upon the software, generating a text string;
b) based upon the text string, generating a first hash value; and
c) comparing the first hash value with a second hash value.

30. The method of claim 29, wherein the act of generating a text string includes generating a text string based upon the name of a software file.

31. The method of claim 29, wherein the act of generating a text string includes generating a text string based upon the date of a software file.

32. The method of claim 29, wherein the act of generating a text string includes generating a text string based upon the directory of a software file.

33. The method of claim 29, wherein the act of generating a text string includes generating a text string based upon the size of a software file.

34. The method of claim 29, wherein the act of comparing the first hash value with a second hash value includes comparing the first hash value with a second hash value that was included on a program storage device that includes the software.

35. The method of claim 29, wherein the act of comparing the first hash value with a second hash value includes comparing the first hash value with a second hash value that was provided via the Internet.

36. The method of claim 29, wherein the act of comparing the first hash value with a second hash value includes comparing the first hash value with a second hash value that was provided via a facsimile.

37. The method of claim 29, wherein the act of comparing the first hash value with a second hash value includes comparing the first hash value with a second hash value that was provided via a telephone call.

38. The method of claim 29, wherein the act of comparing the first hash value with a second hash value includes comparing the first hash value with a second hash value that was provided via an email.

39. The method of claim 29, wherein the act of comparing the first hash value with a second hash value includes comparing the first hash value with a second hash value that was provided via a written document.
